(19) United States
(12) Patent Application Publication
(10) Pub. No.: US 2021/0148440 A1
(43) Pub. Date: May 20, 2021

(54) BELT TENSIONING SYSTEM

(71) Applicant: HEWLETT-PACKARD DEVELOPMENT COMPANY, L.P., SPRING, TX (US)

(72) Inventors: Niels Sanchez van den Beuken, Sant Cugat del Valles (ES); Sergi Culubret I Cortada, Sant Cugat del Valles (ES); Bartomeu Gaya Pol, Sant Cugat del Valles (ES)

(73) Assignee: HEWLETT-PACKARD DEVELOPMENT COMPANY, L.P., SPRING, TX (US)

(21) Appl. No.: 17/047,582

(22) PCT Filed: May 17, 2018
(86) PCT No.: PCT/US2018/033254

§ 371 Date: Oct. 14, 2020

(51) Int. Cl. F16H 19/06; H04N 1/10; B41J 29/38

(52) U.S. Cl. CPC F16H 19/0672; H04N 1/1039; F16H 2019/0686; B41J 29/38; H04N 1/1026

(57) ABSTRACT

A belt tensioning system is described, which comprises: a housing pivotable about a pivot point; a pulley supported by said housing, said pulley to rotate a belt and said pulley rotatable about an axis of rotation; a motor to drive the pulley; and a biasing element coupled to said housing and to apply a tension to said belt via said housing and said pulley; wherein operation of said motor to effect rotation of said pulley about said axis of rotation: in a first direction effects pivoting of said housing in a direction about said pivot point, which pivoting movement, in combination with said biasing element, effects translational movement of said axis of rotation of said pulley in a first translational direction to a first axis position to alter said tension in said belt; and in a second direction effects pivoting of said housing in an opposite direction about said pivot point, which pivoting movement, in combination with said biasing element, effects translational movement of said axis of rotation of said pulley in a second translational direction to a second axis position to alter said tension in said belt.

### BACKGROUND

In a printing operation of a printing device, a carriage, which includes a print head, is moved relative to a print media item for ejection of print agent from the print head onto the print media item. The carriage may move along a carriage rod and may be propelled along the carriage rod by a drive mechanism that includes a motor and a flexible belt. A carriage such as that described above can be employed in printing devices for printing inks and in 3D printing devices wherein layers of build material are selectively solidified by layers with the aid of printing fluids that are printed to the layers of build material.

Similarly, in a scanning operation of a scanning device, which may be included in multifunction printers (MFPs) and other devices, a document to be scanned is placed on a transparent window for scanning. The document may be placed, face down (i.e., where “face” refers to the side of the document to be scanned) on one side of the window. A carriage, which has coupled thereto a scan bar including optics for scanning the document, may then be moved along the length of the opposite side of the window, e.g., along a carriage rod. The carriage, and thus the scan bar, may be propelled along the carriage rod by a drive mechanism that includes a motor and a flexible belt.

### BRIEF DESCRIPTION OF THE DRAWINGS

FIG. 1 illustrates a schematic representation of a drive mechanism for driving a carriage of a printing device according to an example, the drive mechanism including a belt tensioning system;

FIG. 2 illustrates a schematic representation of a drive mechanism for driving a carriage of a scanning device according to an example, the drive mechanism including a belt tensioning system;

FIG. 3 illustrates a more detailed view (perspective view) of an example of a belt tensioning system;

FIG. 4 illustrates a perspective view of an example of a belt tensioning system from a different perspective to that illustrated in FIG. 3;

FIG. 5 illustrates a plan view of an example of a belt tensioning system as illustrated in FIGS. 3 and 4;

FIGS. 6a to 6c are simplified illustrations of elements of the drive mechanism and belt tensioning system to illustrate relative movements when a belt of the drive mechanism is driven in a first direction; and

FIGS. 7a to 7c are simplified illustrations of elements of the drive mechanism and belt tensioning system to illustrate relative movements when a belt of the drive mechanism is driven in a second direction.

### DETAILED DESCRIPTION

In one example, the present disclosure describes a belt tensioning system for use in a printing device. However, in another example, the belt tensioning system of the present disclosure can be incorporated in a scanning device.

As discussed above, the drive mechanism that is used to propel a carriage, to which is coupled a print head, when printing a document comprises a motor and a flexible belt. A tensioning system may be used to apply a constant force that maintains the proper amount of tension in the belt. In the present disclosure, the motor and the tensioning system are placed at the same end of the carriage rod, with the tensioning system acting upon a driven pulley coupled to an output of the motor. The tension applied to the belt by the tensioning system may be increased or decreased dependent upon the direction of rotation of the output of the motor to ensure balance of forces on both sides of the belt.

Similarly, in the Case of a Scanning Device, the Drive Mechanism that is Used to propel a carriage, to which is coupled a scan bar, when scanning a document comprises a motor and a flexible belt. A tensioning system may be used to apply a constant force that maintains the proper amount of tension in the belt. Again, in the present disclosure, the motor and the tensioning system are placed at the same end of the carriage rod, with the tensioning system acting upon a driven pulley coupled to an output of the motor. The tension applied to the belt by the tensioning system may be increased or decreased dependent upon the direction of rotation of the output of the motor to ensure balance of forces on both sides of the belt.

Examples of the present disclosure describe a belt tensioning system that is mounted adjacent the motor to apply a bias to the driven pulley coupled to the output of the motor.

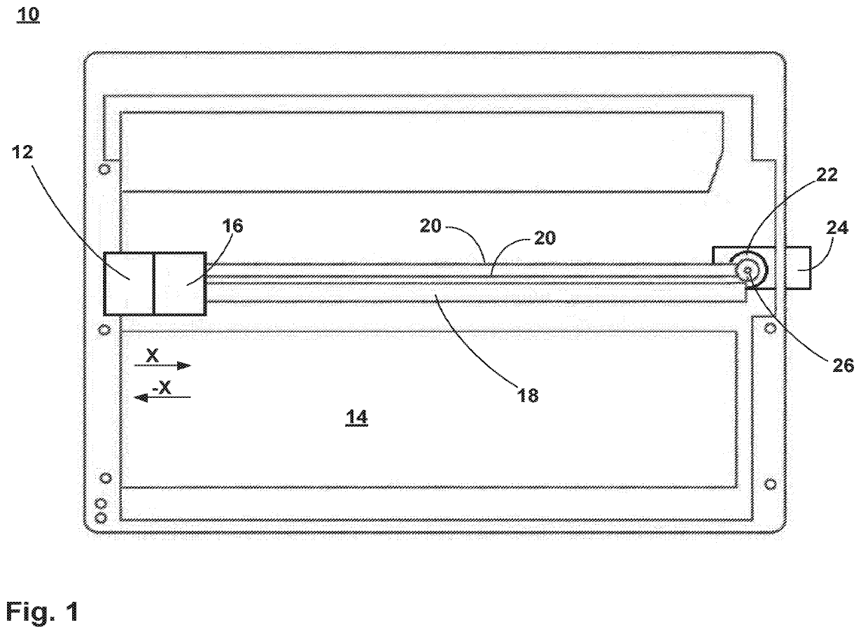

FIG. 1 illustrates an example of a printing device 10 and schematically illustrates elements of a drive mechanism for driving a carriage of the printing device and a belt tensioning system for applying tension to a belt of the drive mechanism.

The printing device 10 comprises a print head 12, which comprises nozzles for ejecting print agent toward print media located in a printing region 14 of the printing device 10.

The print head 12 is coupled to a carriage 16 of the drive mechanism. The drive mechanism drives the carriage 16 of the printing device 10, and thus the print head 12.

In particular, FIG. 1 illustrates a view of the printing device 10 from above printing region 14 of the printing device 10.

The drive mechanism for driving the carriage 16, and print head 12, comprises a carriage rod 18, a belt 20 and a motor 22.

In addition to forming part of the drive mechanism for driving the carriage 16, the motor 22 also forms part of belt tensioning system 24, which can adjust the tension in belt 20 based upon the direction of rotation of the motor output (which is related to the direction of movement of the carriage 16, i.e. see arrows X and −X in FIG. 1 used to indicate movement directions of the carriage). The scanning direction (X, −X) of the carriage 16, and print head 12, is perpendicular to a print media advance direction.

In one example, the carriage rod 18 comprises a generally linear rod or shaft that extends along the length of the window 14 and on which the carriage 16 that carries print head 12 is mounted. The carriage 16 can move back and forth along the length of the carriage rod 18 (e.g., from left to right (X) and right to left (−X) in FIG. 1) in order to eject print agent toward print media located in the printing region 14. For instance, the carriage 16, and thus the print head 12, may move in one direction to print one pass on the document, and then move in the opposite direction to return to its starting position (e.g., so that it is ready to print a next pass document). Alternatively, the print head 12 may complete a print pass in each direction (i.e. X and −X), moving first in one direction and then in the opposite direction.

In one example, the belt 20 comprises a loop of an elastic material. The belt 20 is positioned in a substantially parallel orientation relative to the carriage rod 18; thus, the belt 20 can extend across the length of the printing region 14. The belt 20 is supported on a set of pulleys, where at least one pulley is mounted near each end of the carriage rod 18. For instance, in the example illustrated in FIG. 1, a first pulley 26 is mounted near one end of the carriage rod 18, while a second pulley (obscured by the print head 12 and carriage 16 in FIG. 1) is mounted near the opposite end of the carriage rod 18. The carriage 16 is mounted to the belt 20, such that when the belt 20 is rotated by the set of pulleys, the carriage 16, and thus the print head 12 is driven along the carriage rod 18.

In the illustrated example, the motor 22 is mounted near one end of the carriage rod 18. An output of motor 22 is coupled to first pulley 26 to drive the first pulley 26. Thus, operation of the motor 22 urges the first pulley 26 (i.e. a driven pulley) into motion, which thereby rotates the belt 20. Rotation of the belt drives the second pulley (i.e. an idle pulley) and causes the carriage 16 to be driven along the carriage rod 18.

The belt tensioning system 24 can adjust the force on the belt 20 dependent upon a direction of rotation of the output of the motor 22 in order to adjust an amount of tension in the belt 20. In the example illustrated in FIG. 1, the belt tensioning system exerts a force on first pulley 26 that pulls the first pulley 26, and thus the belt 20, toward the belt tensioning system 24 in a direction denoted by arrow X (e.g. to the right of the figure).

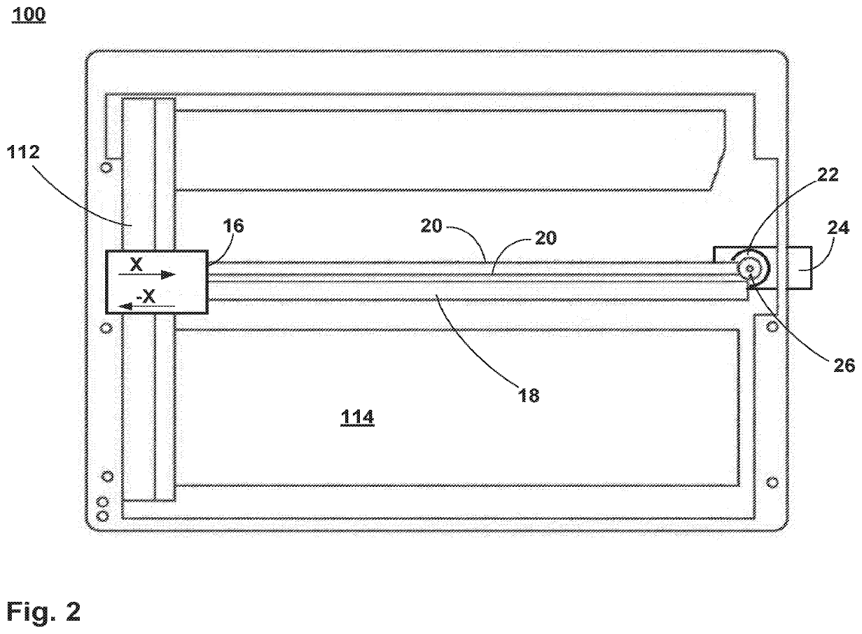

FIG. 2 illustrates an example of a scanning device 100 and schematically illustrates elements of a drive mechanism for driving a carriage of the scanning device and a belt tensioning system for applying tension to a belt of the drive mechanism. Features of the belt tensioning system are the same as those described above in relation to FIG. 1 and are denoted using the same reference numerals.

The scanning device 100 comprises a scan bar 112, which comprises various optics for scanning a document located on a window 114 of the scanning device 100, including, for example, a light source (e.g., a light emitting diode), lens, sensor (e.g., photodetector), and the like.

The scan bar 112 is coupled to a carriage 16 of the drive mechanism. The drive mechanism drives the carriage 16 of the scanning device 100, and thus the scan bar 112.

In particular, FIG. 1 illustrates a view of the scanning device 100 from an underside of window 114 of the scanning device 100 (e.g., the surface upon which a document is placed for scanning). Thus, the window 114 can be generally rectangular in shape, with various components of the drive mechanism located on the periphery of the rectangle.

The drive mechanism for driving the carriage 16, and scan bar 112, comprises the carriage rod 18, belt 20 and motor 22.

In one example, the carriage rod 18 comprises a generally linear rod or shaft that extends along the length of the window 114 and on which the carriage 16 that carries scan bar 112 is mounted. The carriage 16 can move back and forth along the length of the carriage rod 18 (e.g., from left to right (X) and right to left (−X) in FIG. 2) in order to scan a document that is placed on the opposite side of the window 14. For instance, the carriage 16, and thus the scan bar 112, may move in one direction to scan the document, and then move in the opposite direction to return to its starting position (e.g., so that it is ready to scan a next document). Alternatively, the scan bar 112 may complete a scan of a document in two passes, moving first in one direction and then in the opposite direction in order to generate sufficient data to reproduce the document.

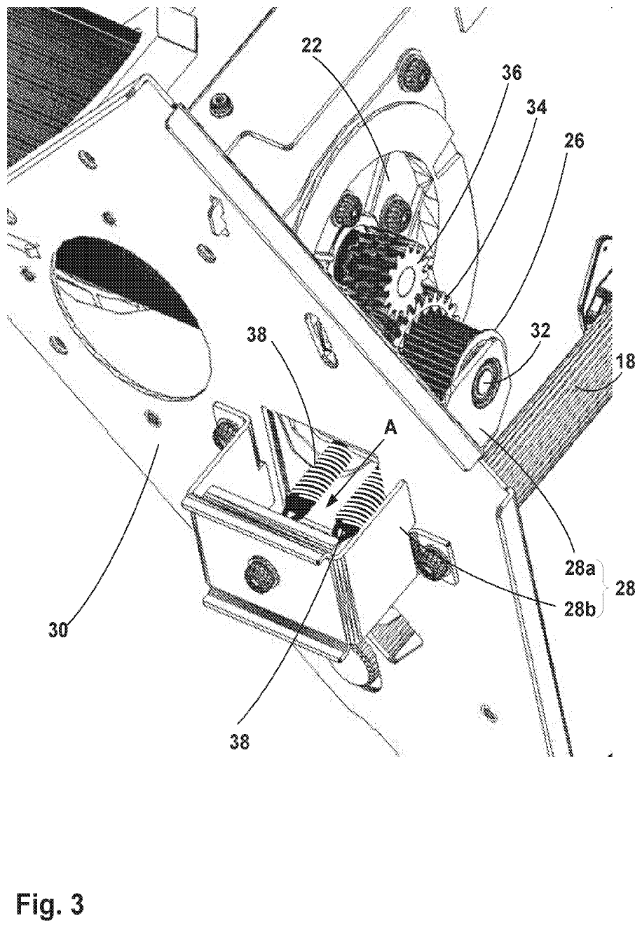

FIG. 3 illustrates a more detailed view (perspective view) of an example of a belt tensioning system 24.

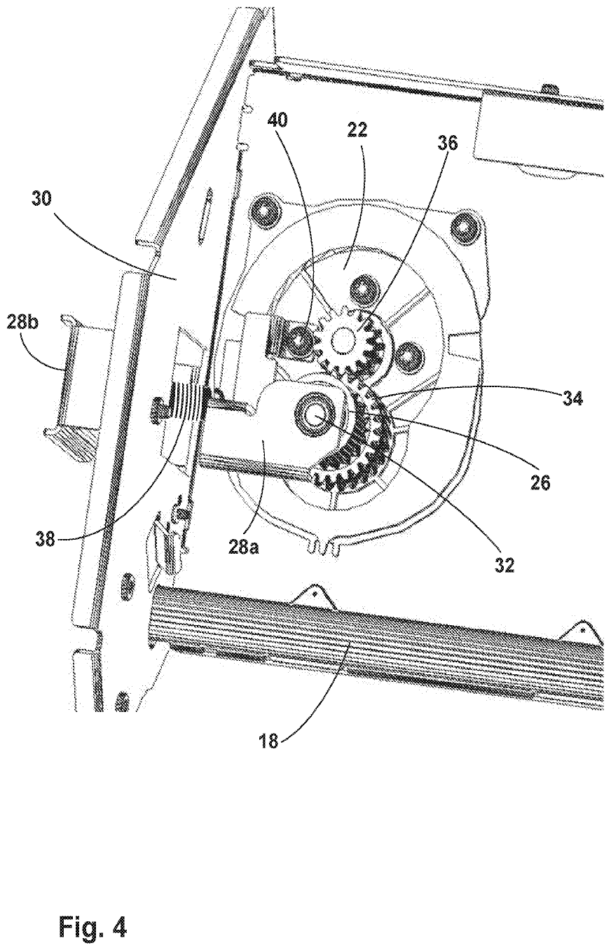

The belt tensioning system 24 comprises a housing 28, which comprises two parts: a first part 28a located on one side of a part of a frame 30 of the scanning device and mounted (not shown in FIG. 2—see FIG. 3 and FIG. 4) to a housing of motor 22; and a second part 28b located on an opposite side of the part of the frame 30, and mounted to the frame 30. The housing 28 supports first pulley 26 and the first pulley 26 is mounted to rotate relative to the housing by a pin 32 which extends through the first pulley 26 and is coupled to parts of the housing 28 at ends thereof. The pin 32 defines an axis of rotation of the first pulley 26 about which the first pulley 26 rotates.

The first pulley 26 is coupled to a gear 34, which is located to engage with a motor output 36. In the illustrated example, the motor output 36 also comprises a gear located to mesh with gear 34. Operation of the motor causes motor output 36 to rotate. Through engagement with gear 34, this causes rotation of first pulley 26 about pin 32 when the motor output 36 is rotated.

The belt tensioning system 24 also comprises a biasing element 38, of which there are two in the illustrated example. In other examples a different number of biasing elements can be employed.

One end of biasing element 38 is coupled to the housing 28 by means of the first part 28a and the other end is coupled to the second part 28b of housing 28. The biasing element 38 can apply a tension to the belt (not shown) in a longitudinal direction of the belt (along the X, direction of FIG. 1) the direction indicated by arrow A in the figure. Tension is applied to the belt by way of the biasing element 38 acting upon the first pulley 26 via first part 28a of housing 28.

In the illustrated example, the biasing element 38 comprises two helical springs.

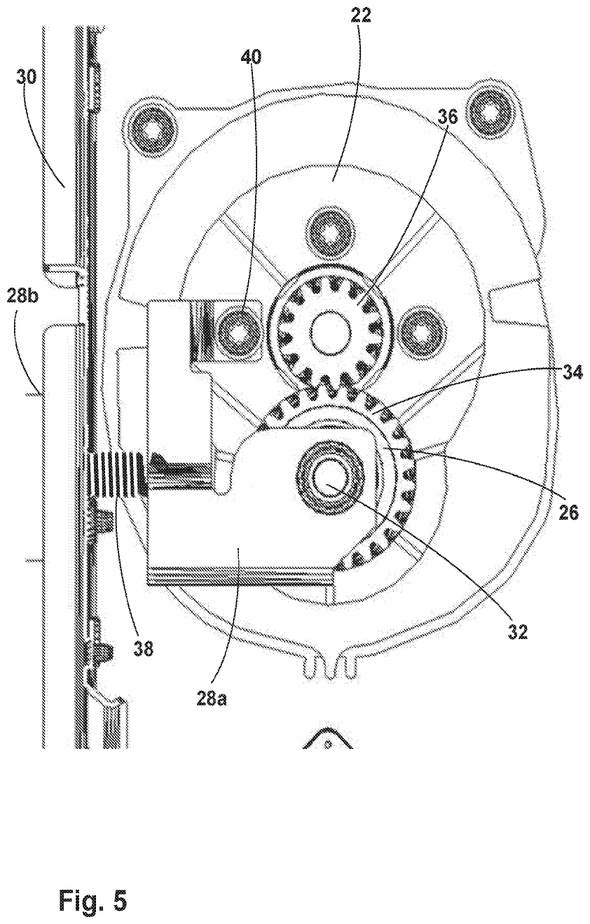

FIG. 4 illustrates a detailed view of an example of a belt tensioning system from a different perspective to that illustrated in FIG. 3. FIG. 5 illustrates a detailed plan view of an example of a belt tensioning system as illustrated in FIGS. 3 and 4. In FIGS. 4 and 5, a mounting element 40 is illustrated, which serves to couple the first part 28a of housing 28 to a housing of motor 22. Mounting element 40 also serves as a pivot point about which the first part 28a of housing can pivot relative to the frame housing of motor 22.

For clarity purposes, the belt is omitted from FIGS. 3 to 5.

Operation of the motor 22 to effect rotation of the first pulley 26 about an axis of rotation of the first pulley 26, as defined by pin 32 in a first direction effects pivoting of the first part 28a of the housing in a direction about the mounting element 40 (i.e. the pivot point), which pivoting movement, in combination with the influence of the biasing element 38, effects translational movement of the axis of rotation of the first pulley 26 in a first translational direction to a first axis position. This alters the tension in the belt by adjusting the force applied to the belt via the pulley, which is influenced by the position of the axis of rotation.

Similarly, operation of the motor 22 to effect rotation of the first pulley 26 about an axis of rotation of the first pulley 26, as defined by pin 32 in a second direction effects pivoting of the first part 28a of the housing in an opposite direction about the mounting element 40 (i.e. the pivot point), which pivoting movement, in combination with the influence of the biasing element 38, effects translational movement of said axis of rotation of the first pulley 26 in a second translational direction to a second axis position. Again, this alters the tension in the belt by adjusting the force applied to the belt via the pulley, which is influenced by the position of the axis of rotation.

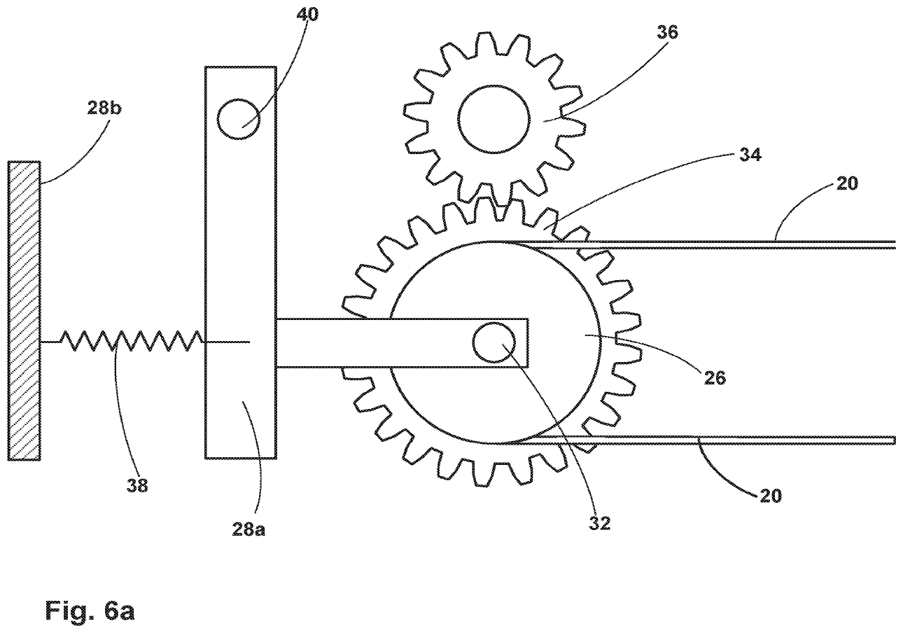

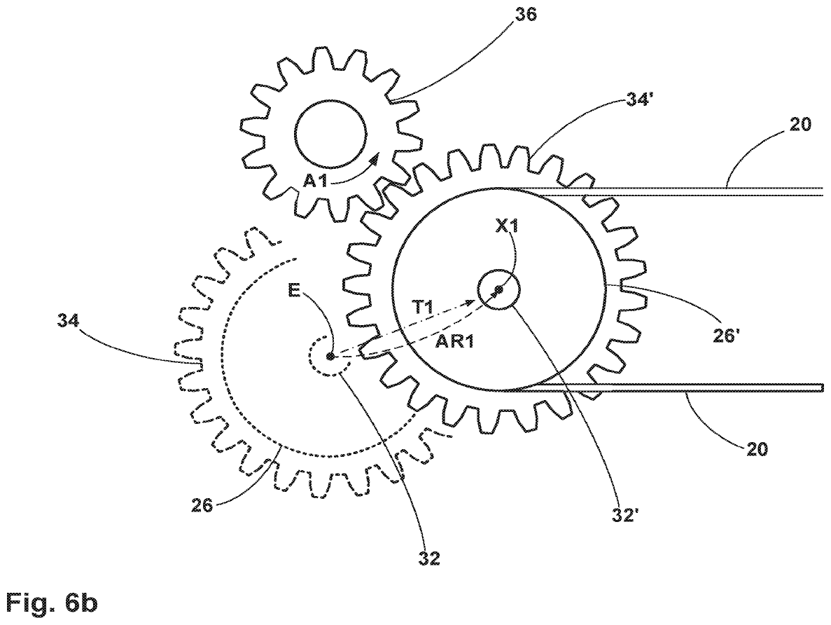

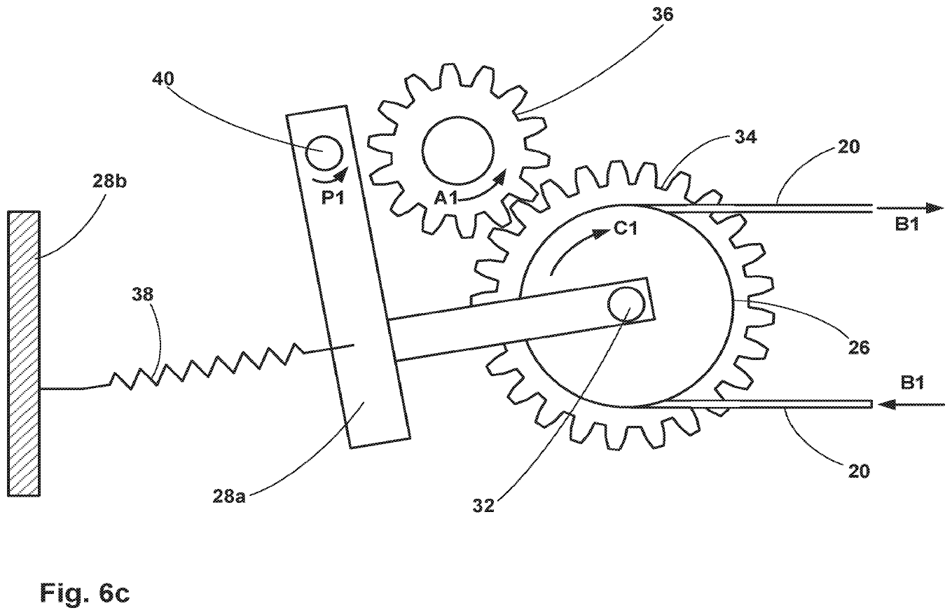

FIGS. 6a to 6c are simplified illustrations of elements of the drive mechanism and belt tensioning system to illustrate relative movements when a belt of the drive mechanism is driven in a first direction.

FIG. 6a illustrates the pulley in an equilibrium condition when the motor is not operational, i.e. when the motor output 36 is not rotating.

FIG. 6b illustrates how the first pulley 26, gear 34 and axis of rotation of the first pulley (defined by pin 32) change when rotation of the motor output 36 in a first direction commences.

In FIG. 6b, the first pulley, gear and pin, when in an equilibrium position, are illustrated using dashed lines. They are denoted by reference numerals 26, 34 and 32 respectively. Upon rotation of the motor output 36 in a first direction (i.e. an anticlockwise direction in FIG. 6b, denoted by arrow A1), the gear 34 and first pulley 26, because they are not fixed in a fixed position, but biased to that position by the influence of the biasing element counteracting a tension in the belt, move with the rotation of the motor output 36 such that an axis of rotation thereof (i.e. defined by pin 32) moves in an arc in a same direction as the first direction (i.e. an anticlockwise direction in FIG. 6b, denoted by arrow AR1). Thus, the axis of rotation of the gear 34 and first pulley 26 is effectively translated in a first translation direction (denoted by arrow T1) from an equilibrium axis position E to a first axis position X1.

The first pulley, gear and pin, when the axis of rotation is in the first axis position X1, are illustrated using solid lines and are denoted by reference numerals 26′, 34′ and 32′ respectively.

Movement of the axis of rotation in this manner is a transient movement that occurs during an initial period following beginning of rotation of the motor output 36.

As can be seen in FIG. 6c, rotation of the motor output 36 in an anticlockwise direction causes the movement of the first pulley 26, gear 34 and pin 32 in the manner described above. The range of movement of these elements is constrained by the first part 28a of the housing, the pivot point 40 of the first part 28a, the biasing element 38 and the belt 20. Movement of gear 34 about motor output 36 causes the first part 28a of housing to pivot about pivot point 40 in a direction indicated by arrow P1 in FIG. 6c. This movement of first part 28a of the housing acts against the bias of the biasing element 38, which urges the first part 28a of housing to an equilibrium position (i.e. as illustrated in FIG. 6a).

Following the initial movement of the first pulley 26, gear 34 and pin 32 from the equilibrium position to the first axis position, the system settles into steady station operation and rotation of gear 36 in direction A1 causes gear 34 to rotate about pin 32 to cause rotation of the pulley 26 in a clockwise direction C1. This causes movement of the belt in a direction indicated by arrows B1.

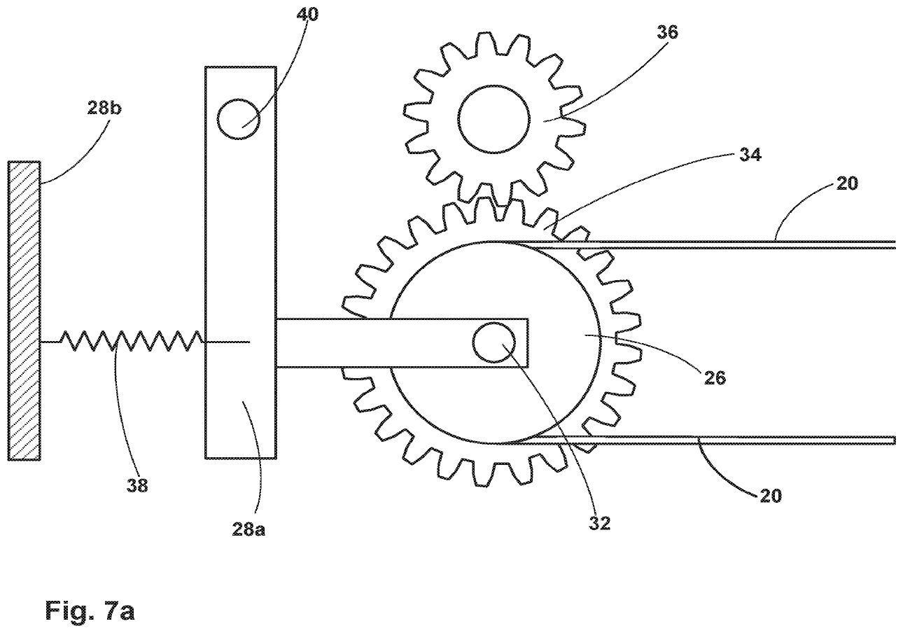

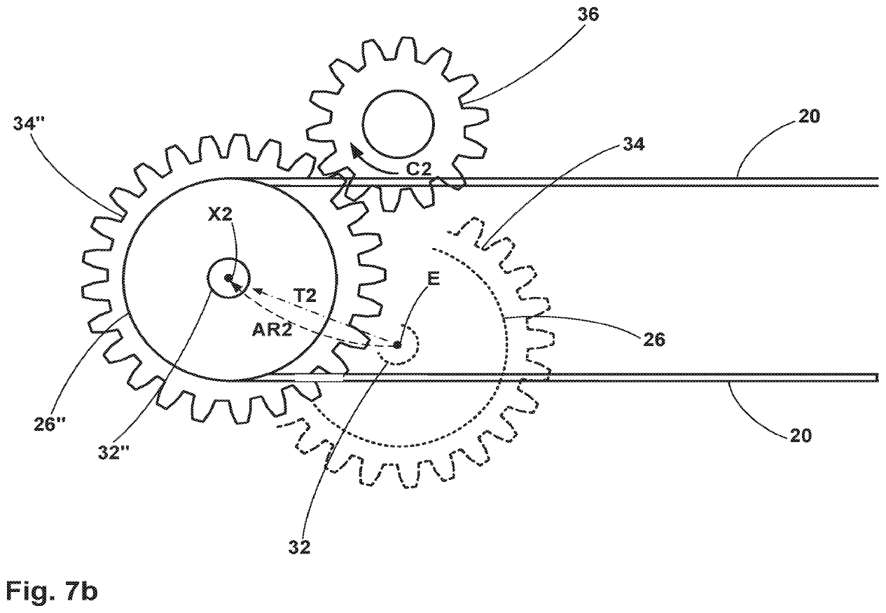

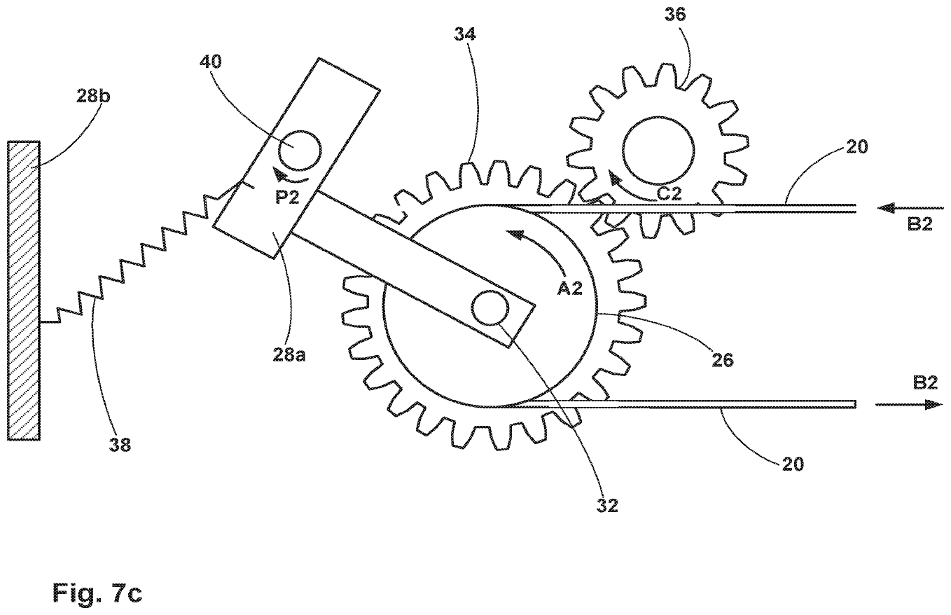

FIGS. 7a to 7c are simplified illustrations of elements of the drive mechanism and belt tensioning system to illustrate relative movements when a belt of the drive mechanism is driven in a second direction.

FIG. 7a illustrates the pulley in an equilibrium condition when the motor is not operational, i.e. when the motor output 36 is not rotating.

FIG. 7b illustrates how the first pulley 26, gear 34 and axis of rotation of the first pulley (defined by pin 32) change when rotation of the motor output 36 in a second direction commences.

In FIG. 7b, the first pulley, gear and pin, when in an equilibrium position, are illustrated using dashed lines. They are denoted by reference numerals 26, 34 and 32 respectively. Upon rotation of the motor output 36 in a second direction (i.e. a clockwise direction in FIG. 7b, denoted by arrow C2), the gear 34 and first pulley 26, because they are not fixed in a fixed position, but biased to that position by the influence of the biasing element counteracting a tension in the belt, move with the rotation of the motor output 36 such that an axis of rotation thereof (i.e. defined by pin 32) moves in an arc in a same direction as the second direction (i.e. a clockwise direction in FIG. 7b, denoted by arrow AR2). Thus, the axis of rotation of the gear 34 and first pulley 26 is effectively translated in a second translation direction (denoted by arrow T2) from an equilibrium axis position E to a second axis position X2.

The first pulley, gear and pin, when the axis of rotation is in the first axis position X2, are illustrated using solid lines and are denoted by reference numerals 26″, 34″ and 32″ respectively.

Movement of the axis of rotation in this manner is a transient movement that occurs during an initial period following beginning of rotation of the motor output 36.

As can be seen in FIG. 7c, rotation of the motor output 36 in a clockwise direction causes the movement of the first pulley 26, gear 34 and pin 32 in the manner described above. The range of movement of these elements is constrained by the first part 28a of the housing, the pivot point 40 of the first part 28a, the biasing element 38 and the belt 20. Movement of gear 34 about motor output 36 causes the first part 28a of housing to pivot about pivot point 40 in a direction indicated by arrow P2 in FIG. 7c. This movement of first part 28a of the housing acts against the bias of the biasing element 38, which urges the first part 28a of housing to an equilibrium position (i.e. as illustrated in FIG. 7a).

Following the initial movement of the first pulley 26, gear 34 and pin 32 from the equilibrium position to the second axis position, the system settles into steady station operation and rotation of gear 36 in direction C2 causes gear 34 to rotate about pin 32 to cause rotation of the pulley 26 in an anticlockwise direction A2. This causes movement of the belt in a direction indicated by arrows B2.

The belt tensioning system of the present disclosure can provide symmetrical tensions in each part of the belt, regardless of the direction in which a carriage is being moved.

Although the housing 28 of the belt tensioning system has been described above as comprising two parts, in another example of the present disclosure, the housing can comprise one part. In such an example, the biasing element 38 is coupled, at one end, to the housing, and at the other end to the frame of the device.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

1. A belt tensioning system, comprising:
a housing pivotable about a pivot point;
a pulley supported by said housing, said pulley to rotate a belt and said pulley rotatable about an axis of rotation;
a motor to drive the pulley; and
a biasing element coupled to said housing and to apply a tension to said belt via said housing and said pulley;
wherein operation of said motor to effect rotation of said pulley about said axis of rotation:
in a first direction effects pivoting of said housing in a direction about said pivot point, which pivoting movement, in combination with said biasing element, effects translational movement of said axis of rotation of said pulley in a first translational direction to a first axis position to alter said tension in said belt; and
in a second direction effects pivoting of said housing in an opposite direction about said pivot point, which pivoting movement, in combination with said biasing element, effects translational movement of said axis of rotation of said pulley in a second translational direction to a second axis position to alter said tension in said belt.

2. A system according to claim 1, wherein said housing comprises a first part, to which said pulley is rotatably mounted and to which a first end of said biasing element is coupled.

3. A system according to claim 2, wherein said housing comprises a second part, to which a second end of said biasing element is coupled.

4. A system according to claim 2, wherein the second end of the biasing element is coupled to a frame of a device to which the system is mounted.

5. A system according to claim 2, wherein said first part is pivotably coupled to said pivot point.

6. A system according to claim 1, wherein said biasing element comprises a helical spring.

7. A system according to claim 1, wherein said biasing element comprises a first biasing element and a second biasing element.

8. A system according to claim 1, wherein said system comprises a printing system, further comprising:
a print medium support surface to support a print medium;
a carriage for supporting a printhead;
a printhead coupled to said carriage, said printhead comprising nozzles to eject a print agent toward said print medium; and
a drive mechanism to drive the printhead along a length of the print medium support surface, the drive mechanism comprising:
an idle pulley spaced from said pulley of said belt tensioning system; and
a belt comprising a loop material supported by said idle pulley and said pulley of said tensioning system.

9. A system according to claim 1, wherein said system comprises a scanning system, further comprising:
a transparent window to support a document to be scanned;
a carriage for supporting a scan bar,
a scan bar coupled to said carriage, said scan bar housing optics to scan said document to be scanned; and
a drive mechanism to drive said scan bar along a length of said window, the drive mechanism comprising:
an idle pulley spaced from said pulley of said belt tensioning system; and
a belt comprising a loop material supported by said idle pulley and said pulley of said tensioning system.

10. A drive mechanism, comprising:
a belt tensioning system according to claim 1;
an idle pulley spaced from said pulley of said belt tensioning system; and
a belt comprising a loop material supported by said idle pulley and said pulley of said tensioning system.

11. A drive mechanism according to claim 10, further comprising a carriage driven by said belt, and moveable between a first position and a second position by rotation of said belt.

12. A drive mechanism according to claim 11, further comprising a scan bar coupled to said carriage, said scan bar housing optics to scan a document.

13. A drive mechanism according to claim 11, further comprising a printhead coupled to said carriage, said printhead comprising nozzles to eject a print agent toward a print medium.
